(19) United States
(12) Patent Application Publication
(10) Pub. No.: US 2007/0005970 A1
(43) Pub. Date: Jan. 4, 2007

(54) E-mail authentication protocol or MAP

(76) Inventors: Steven E. Trupp, Brightwaters, NY (US); Peter Theobald, Huntington, NY (US); Robert Bente, Oakdale, NY (US)

Correspondence Address: FUTERES TECHNOLOGY, P.O. BOX451, BOHEMIA, NY, 11716, US

(21) Appl. No.: 11/089,558

(22) Filed: May 21, 2003

(51) Int. Cl. H04L 9/00

(52) U.S. Cl. 713/170

(57) ABSTRACT

The invention is a more efficient system and method to eliminate undesirable electronic mail (email) communications sent via the Internet. The invention eliminates undesirable email by refusing to accept delivery of the email message thereby minimizing the negative impact of undesirable email while adhering to established Internet protocols and processes guiding email Delivery Status Notifications. The invention does not evaluate or scrutinize the actual contents of an email message, thereby avoiding false positives (blocking of desirable email) and the real or perceived invasion of privacy issues associated with scanning personal and business email communications. The invention executes unilaterally and is universally adaptable as it evaluates the TCP/IP and SMTP protocol and transmission data attendant with every email message. The invention operates independently, is not dependant on any third party lists or definitions of spam and does not require any pre or post delivery coordination between senders or recipients.

The following information constitutes an overview of the present invention. Included in this document are:
1. A summary of the invention and its immediate and potential applications, and
2. An overview of its core features and functions

A complete application for U.S. protection will be filed within the timeframes prescribed by 35 USC and both system and method claims will be made. This Provisional Patent Application is tendered pursuant to 35 U.S.C. 271 and all rights and benefits of that section are claimed.

### Part 1: SUMMARY OF INVENTION

The invention is directed to the detection and controlled disposition of ‘spam’ or Unsolicited Commercial Email (“UCE”) sent across electronic networks such as the Internet and which utilize standard Internet mail transmission technology. The invention represents an automated system that can verify and authenticate certain key features of Internet email messages and does so without actually taking receipt of the message that is being assessed. This provides a number of advantages, not the least of which is that the user of the invention does not have to take possession of a spam message in order to perform an evaluation as to whether the message is spam. Thus an email user seeking to avoid spam need not receive and then dispose of the spam email, they can avoid receipt entirely. A second benefit is to network services operators, such as those supporting mail relay systems, in that much spam cannot be properly delivered or returned to the sender, and if a network operator takes receipt of an email message, that operator is obligated under existing informal Internet mail processing standards to continue to try to deliver or return such message, often for up to five (5) days, even though the message lacks critical information needed to perform this function. Finally, the invention respects the business and economic realities by allowing the sending of email to recipients with whom the sender has no prior relationship (e.g. electronic direct marketing) by only requiring such sender to properly address their email and ensure that a return email address or return path is available for the recipient to use to contact the sender. The invention therefore speaks to the needs to senders, processors and recipients of Internet email.

The invention also improves upon existing anti-spam technology because it does not filter or restrict email messages based on content of the message, email address, originating domain or other predetermined criterion. Many existing spam detection systems rely upon restricting messages based upon detection of specific words or characters in the body or subject of the email message, or by keeping or otherwise checking lists of known spam senders or third party systems believed to be illegally used by or vulnerable to unauthorized use by spam senders. These methods are inherently ineffective because the professional spam senders will deliberately make minor changes to message content or will rotate and change sending email addresses to defeat content checking or list based filtering systems. A prime objective of the invention was establishing a mail authentication system that could avoid these problems and add the additional significant benefit of not requiring significant ongoing human involvement once the system is installed and configured.

The present invention overcomes limitations of existing spam detection/suppression systems by operating in some ways as an Internet “mail policeman” essentially forcing the sender of an email message to include in any message certain basic and accurate data about the sender and the transmission route. It does not, by design, assess the body or contents of the message. The invention requires that the sender of an email message be able to receive email to the same email address as was used when the message was sent. The data required to be present includes, but is not limited to, the sender's email address. A common problem of spam is that the senders intentionally use fake or forged “Trom” addresses that don't allow the recipient to reply to the sender. Having a valid “From” or reply address is key to allowing a recipient to either do business with an email sender or to complain to the sender if they feel the message is improper, or if the recipient wishes to be removed from the sender list to avoid receiving further correspondence from this sender. Most importantly, the invention is sender neutral. That is, so long as a sender includes a valid email “from” address and includes other reliable information (including but not limited to the maintaining of a valid email address on the email server sending the email) the email will be processed by MAP. MAP essentially forces email senders to be ethical and to include such basic and reliable information as will allow a recipient to reach out and contact and locate the email sender. In many ways, MAP is sender and receiver neutral allowing the senders of bulk marketing email to do so, and allowing potential customers to receive such commercial communications, but the system requires all such messages to be traceable and able to be responded to. The invention operates by using proprietary “sensing” technology that allows a MAP enabled mail system to examine certain attributes of a message without actually receiving the message. The sensing is achieved by anticipating the existing functionality of Internet email transmission systems whereby portions of the email transmission data are captured for evaluation by MAP, without MAP causing actual receipt of the email. The MAP system will then determine whether the message should be accepted or rejected.

The invention operates in conjunction with the Internet mail transmission system known as Simple Mail Transport Protocol (SMTP). The invention can be installed at any location on the internet where the invention invokes certain routines and operations in conjunction with an/the SMTP processor, and also contains operates by subjecting every email sent to be received by an SMTP process to a series of tests and authentication protocols. It is primarily directed to detecting and barring the reciept at a protected system of all unauthenticated email messages. In operation, the system verifies the source of, and/or the third party responsible for sending any email message before accepting receipt of the message. In application, this unique and novel anti-spam service and invention is called MAP (“Mail Authentication Protocol”). The invention is primarily directed to detecting and controlling the disposition of an unauthenticated email message. The invention is further directed to identifying when a fraudulent or forged email sender address has been used (or is attempted to be used) and where a server forwarding a message, or its designated alternate server, cannot verify the authenticity of a given email address claimed by the sender as their “from” or reply address.

The invention is an integrated system, ideally installed either at a network location as an intermediary mail relay point between the sender and a designated recipient or placed at the recipient locales such as a corporate email server or an ISP's inbound email processing locations. It comprises a series of proprietary methods and a series of software and system processes that collectively serve to detect and allow controlled processing of a message. It works in conjunction with any system running the Simple Mail Transfer Protocol (SMTP or it's derivatives such as ESMTP) that receives email messages sent across electronic networks running transmission control protocol/internet protocol (TCP/IP).

The invention overcomes an array of limitations presented by present anti-spam email solutions including:
1. It does not depend on content filtering where keywords or pattern analysis is used in an attempt to detect spam. These systems are overcome and can be defeated by spammers by knowing the keywords being sought or by understanding the pattern algorithm being used and varying the message payload to defeat the filter.
2. It does not depend upon content analysis with attendant personal privacy concerns and security issues.
3. It does not require any coordination between a sender and a recipient to ensure mail can be sent and received. Some systems rely on a challenge and response technique, or a pre-approved list of senders approach, each of which require some level of coordination or additional communications between a sender and a recipient in order to ensure mail may be sent and/or received. Rather, any validly configured message will pass MAP if the sender's identity (as described herein) can be fully authenticated.
4. It is entirely passive and once configured requires minimal administration and does not introduce any SPOF (Single Point of Failure) with respect to the delivery of email or delay the delivery of email messages. This enhances system reliability and ensures email is processed and delivered.
5. It may be used in conjunction with any existing anti-spam applications or systems to compliment the operations of these systems.

The MAP system is neutral in application in that it processes all mail provided the email is itself properly identified and MAP does not specifically target for rejection email because it is UCE (Unsolicited Commercial Emil) or spam; rather MAP requires that sender of UCE must confirm the source of the UCE, their accountability as the sender as well as confirm their UCE sending systems are available and responsive directly by the recipient of the UCE, for example when the recipient sends a “Remove from mailing list Request” and that request is sent via SMTP.

### Part 2: Overview of Functions and Benefits

MAP evaluates an email message by remotely discovering certain specifics of the email message header information also referred to as the ‘envelop.’ This allows determination of whether adequate sender data and other information have been included without taking possession of the subject email message. An email message essentially has two components—email header or envelop information and an email payload. Payload generally refers to the actual message that is being sent and includes any attachments or additional information or materials. Header or envelop information contains the essential routing data, formatted per the SMTP protocol, which provides the email message with its ultimate destination as well as the return path to the sender or the responsible party acting on behalf of the sender. All email transported across the Internet requires that at least two servers or computers executing the SMTP protocol, one server sends and one server receives, both or all or which servers are utilizing, dependant on, and have access to, DNS (Domain Name System) servers. DNS servers function as the routing directory for SMTP servers. All Internet email should properly include a sender address and a recipient address, which addresses include a domain name (The domain name is the portion of an email address after the @ sign).

In operation, SMTP servers read the domain name portion of an email address and look up the route as to where to send an email addressed to that domain on a DNS server. Every unique domain name has as part of its domain name registration, a NS (Name Server) this being the location of the domain's DNS records, where an SMTP server, directly or indirectly, will determine where to send an Internet addressed email to that domain.

The SMTP protocol operates under the premise that mail delivery must be attempted. The systems will either deliver an Internet addressed email or it will confirm back to the sender that it was unable to deliver an internet-addressed email. To do this an SMTP server sending an email must confirm that the domain the email is addressed to must exist in that there are NS servers registered for this domain, and that there is a DNS record on the NS server indicating where to send email addressed to this domain. Conversely, an SMTP server receiving an email from any SMTP sending server determines the senders address, specifically the domain portion of this address and checks that this domain exists, in that there are NS servers registered for this domain. The check by the receiving SMTP server that the domain exists is performed to support that underlying SMTP protocol foundation that if the Internet email message cannot be delivered to the recipient that SMTP will be able to return a confirmation to the sender indicating a failed delivery event and/or conditions associated with an undeliverable message. This check performed by a SMTP receiving server, that the domain indicated as part of a senders address must exist is perceived as, and in fact functions as, a limited security check, thereby preventing the use of bogus or non-existent domain names as part of an email address, however this check is limited to determining only that the domain exists as per the existence of registered NS servers for the domain.

As a receiving SMTP server checks only that the domain portion of the senders address must exist there is no further examination by SMTP as to whether an email message can actually be sent to or returned to the sender, a feature of SMTP that is routinely taken advantage of by senders of UCE who wish to hide or obscure the source of the UCE and where the MAP protocol is applied to the Internet email systems to defeat this type of abuse in that an accountable source of the UCE must be verified before MAP will signal SMTP to accept a message from the sender.

When MAP is deployed on an SMTP receiving server it can fully authenticate the return address of a sender to determine if the sender of an email is attempting to forge or falsify, through omission or otherwise, that there is a verifiable return address for the sender or more specifically that there is a party that will/can be accountable, as, or on behalf of, the sender of an Internet email.

Included in the critical header information is data telling the internet SMTP mail system who sent the message, from what server the message was sent, and to whom it should be directed for reciept (other non-relevant data is included in the header). SMTP email (and most internet traffic) essentially is received and forwarded by a series of servers and routers. The header information guides an email message through these server and router ‘gates.’ Today, a forged or bogus email address (often used by spammers) will be forwarded across the internet and the routers and servers processing such a message will not verify adequately or completely, certain characteristics of the message to determine if it has valid email header data. MAP introduces what could be called an ‘intelligent gate’ in that a server running MAP becomes a “smart” gate imposing certain ‘rules’ on mail sent through it. MAP does this by using sophisticated ‘sniffing’ or data sensing technology allowing the MAP enabled server to capture essential data associated with the email header/envelop data concerning the email which is being attempted to be sent to the server running MAP. Most significantly, however, MAP acquires this information without formally accepting the message under SMTP rules. This allows for the examination and confirmation of the email address of the email sender, and also allows for the determination of the status of the sender's email account at the server that is claimed to be associated with such email account. The invention has been designed to detect and confirm when false or forged elements are included in a senders email address which suggests the sender is issuing spam or UCE and prevents reciept of the unauthenticated message at the receiving or destination server (or at any server or MAP enabled monitoring point in the email transmission chain). The invention uses multiple verification routines and only those email messages, which pass all such tests, are formally received by the MAP enabled mail server. Notably, the invention can preserve an abstract of the header information of all messages processed, found to lack the required verification elements and denied reciept at the MAP enabled server.

At its core the invention operates by monitoring incoming mail in real time, and before the incoming mail message is actually received, it determines or tests that incoming message as if that message was to be sent back to the sender as outgoing mail. In all cases MAP determines and records the network address and host name of the mail server attempting to send email, (as established during the SMTP connection function), the stated fully qualified email address (as established as the SMTP MAIL FROM function) the intended recipients fully qualified email address (as established as the SMTP RCPT TO: function) and the “SUBJECT” of the email, if any, (as established during the initial transmission of the SMTP DATA:). The invention accomplishes the examination and recording of this information, which is the first and mandatory step in the MAP process, entirely passively by essentially eavesdropping on the established SMTP session. Because every SMTP session is a result of a request by a sending server attempting to send an email, there is always a unique session ID created on the receiving SMTP server, for each attempt to send an email, and this occurs regardless if a receiving mail server is a MAP equipped/configured system. As all Internet email is transmitted via the SMTP (Simple Mail Transfer Protocol) standard, which standard requires that both the sending and receiving mail servers include a minimum/mandatory number of commands and responses, any Internet mail server is a candidate, without modification of the SMTP protocol/process, for a MAP implementation. The passive and background operation of MAP, and the importance of this aspect of the invention, is further amplified in that MAP does not represent, for any MAP equipped mail server, any new or additional SPOF (Single Point of Failure) that could affect the delivery of an email, or introduce any noticeable delay in the delivery of an email. The invention has been designed to passively inspect only the SMTP connection and addressing elements of and inbound email message for use during the MAP authentication process, and does not inspect, evaluate, record, or “see” any aspect or elements of the actual email correspondence. This is in contrast to many other email anti-spam solutions that involve interrogation of the message contents with attendant privacy implications. The MAP system does record the Subject: of an email message but only for the purpose of supplementing/complimenting the MAP system reports comprising “Email traffic statistics and Spam reports” and does not utilize the content, actual data or lack thereof, of/in an email Subject: as part of the MAP authentication process. The invention uses multiple verification routines and only those email messages, which pass MAP verification, are allowed (accepted for subsequent transport) by the SMTP process. Messages that fail a MAP authentication process are “Rejected.” Messages that MAP can not conclusively verify are “Deferred.” MAP thus operates in a way that fully implements and is fully compliant with existing SMTP commands and protocol.

The invention is an integrated system comprising a set of methods and a series of processes that collectively serve to detect and suppress or deny reciept (i.e. ensure non-transmission) of any email correspondence that fails the MAP verification procedures. This suppression of any subject correspondence is executed by refusing to accept or complete the inbound email transaction initiated by the sending server. The system does not need to queue or otherwise store, for later inspection, (via automated pattern matching systems or human inspection) or a final determination, any email message that fails the MAP authentication. This is especially important to Internet service providers and network operators who would be ideal users of MAP. These entities do not want to take possession of spam with the attendant obligation and burden to either attempt to deliver or to return to the sender these messages that by the design of the spam sender have false addresses and are not meant to be able to be returned.

A significant feature of the invention is that it determines the status of a given transmission in real-time where real-time means that the verification is done substantially concurrent with when the request to send a message is actually initiated by the sending server. The invention is deployed by installation at any intermediary point between a sender of an email message and an intended recipient, which in the case of internet email verification, allows the invention to be deployed and installed at literally any location accessible on the internet and the only requirement is the monitoring point must allow for email traffic to be regularly and routinely routed to the MAP equipped SMTP server, processed as per the MAP invention and then relayed on to the ultimate intended recipient. Essentially, MAP may be run almost anywhere that an SMTP enabled server is present.

Systems Environment.

The invention is presently deployed and has been tested as a part of a suite of services offered by a network services provider that processes email on behalf of third party clients. The invention was previously believed by experts in the industry to be impossible for at least three main reasons:
1. Delay in transport of email. It was believed that any effective anti-spam solution as per the MAP invention would necessarily entail introducing an unacceptable delay or latency to messages the MAP system processed and authenticated.
2. Burden on computer processors. It was believed that the increase in demand on the processing power of the computer servers (which run SMTP) would be so great as to make non-economic, or cost-prohibitive, any effective intermediary and real-time processing of email to detect and remove spam.
3. Increase in needed network transport resources or bandwidth constraints. It was believed that any reliable spam or fraudulent network communication detection system would necessarily entail a significant (order or magnitude or greater) increase in the required data transport capacity or bandwidth of a given network. This was because it was believed that material amounts of data would need to be routed between the invention situated at some intermediary monitoring point and those network points at which messages originate and that such data transport volume would again make non-economic or prohibitively costly the operation of the intermediary detection system.

The invention addresses all of these shortcomings and achieves near 100% detection and suppression of email transmissions that cannot be authenticated as per the MAP System and does so 1) without any material delay or latency in the transmission of a given message, 2) does so with only a minimal increase in the computer server processing load (believed to be a increase of less than 10%), and 3) without materially increasing the bandwidth or data transport requirements of the entity operating the invention because the invention monitors and processes only minimal amounts of email related data.

Presently, the invention is offered to the public under a fee based service agreement with ICS Network Systems, Inc. offered as a part of the Mail Sentry brand email services. The Mail Sentry service is configured as a mail relay service and as such represents an ideal intermediary location to process and authenticate messages because a mail relay service is neither the initial source nor a final destination of email traffic. Mail Sentry deploys the MAP invention as this ‘middle-man’ location to intercept, process and authenticate every message before relay to a Customer. The invention is designed to work equally well in an email systems/services implementations where the mail servers are either the final destination or the initial source of an email correspondence.

Other service elements of the Mail Sentry systems are Gateway virus scanning Services and anti-mail relay security. Customers utilizing the Mail Sentry service publish, as part of their establishment of internet domain DNS (Domain Naming Service) records, Mail Exchanger (MX) records that route email for their domain exclusively through the designated Mail Sentry systems for subsequent relay to Customers premise based email server or to the Mail Sentry Network mailboxes. In short, these customers out-source to Mail Sentry the functions of virus scanning and email integrity checking as per the MAP anti-spam invention for all of their corporate email. With current estimates indicating that up to 60% of email to corporate mailboxes being spam, businesses and network operators themselves are keenly interested in reducing the amount of spam they receive or the networks carry.

MAP was conceived and developed to significantly reduce the number of un-solicited email correspondence to both Mail Sentry Gateway and Network Mail box subscribers. The impetus for the invention was manifold but two were primary:
1) Customers were burdened and upset by the amount of spam they received especially the type of spam considered offensive and or offering illegal products, and which in practice nearly always, has a false or forged sender address.
2) The network or email service provider, operating as a mail relay provider, was paying for bandwidth to transport the spam traffic (that could never be associated with a valid recipients email address) thereby burdening the network operator with the high overhead characteristic of trying to return bounce messages or notifications regarding undeliverable email.

The MAP system includes, but is not limited to, an on-line verification process of any senders fully qualified email address who wishes/intends to correspond with anyone whose traffic is processed by a MAP equipped system. This is very important to those who legitimately use email for mass communication. Sending email through a MAP system requires that a sender of an electronic message properly identify their actual email address and ensure that such email address is properly configured and recognized by their email servers. This authentication function ensures that if a party wants to send email to someone they do not have a pre-existing relationship with, they can do so provided they properly identify themselves as well as the server sending the email. This allows for a recipient to reach back and contact the sender. A prime problem with spam today is that a recipient of an unsolicited message is often unable to contact the party sending the message because the return address is false or the server at which such address is listed does not recognize or confirm such address. MAP thus allows the direct marketing industry and others to still communicate with members of the public and inform them of commercial opportunities, but does so in a way that compels the sender to include proper and accurate information on how to contact the sender. Accordingly, MAP balances the interests of commercial senders with email recipients and imposes certain basic levels of required proper identification if messages are to be allowed through MAP.

Relationship of MAP and SMTP

The MAP system utilizes proprietary application software that is fully integrated with the industry standard SMTP (Simple Mail Transfer Protocol). As soon as an inbound SMTP connection to a MAP enabled server is established, the MAP protocol determines the relevant senders address and connection data and immediately initiates/performs the following tasks.
1) The return mail route for the senders email address is determined via an Mx record lookup for the sender's domain. (If no MX record is published, a host (A) record for the domain is sought);
2) A telnet connection to port 25 on the host specified for the senders Mx record is immediately attempted, and if established;
3) A HELO or EHLO with the Mail Sentry host name is sent;
4) The senders fully qualified email address and the intended fully qualified recipient address are then presented to the MX host for verification.
5) Using the intended recipient address as the mail from: and the senders address as the rcpt to: the MAP process determines whether the Mx host will validate the senders address at or before a timeout value is exceeded for each of the MAP events;
6) The MAP system then evaluates the response(s) to the MAP query and instructs the local SMTP process, established during the inbound mail connection, how to proceed with respect to the pending SMTP transaction. Accept, Reject or Defer.
7) Depending on which determination the MAP system assigns to the inbound delivery request, MAP instructs the SMTP process as to which, if any standard SMTP protocol Status response to issue to the sending server. If MAP assigns an Accept designation, the SMTP process is signaled to continue/complete the inbound SMTP without further consideration of the MAP process which is terminated. If the MAP authentication has failed, MAP instructs the SMTP process to issue a 500 Series error to the sending server “Message Not Accepted” If the MAP verification is not conclusive, MAP instructs SMTP to issue a 400 Series error “Message Temporarily not accepted, Deferred” Please try again later.

The MAP verification process is initiated immediately upon receiving a connection from the sending server and logs the process ID (PID) of the established SMTP connection to support the inter-process dialogue between the local SMTP and MAP protocols. The SMTP process is performing its own SMTP connection edits and checks which process is not interfered with by the MAP process. Until such time as the MAP process determines the ultimate status designated for the inbound correspondence, (Accept, Reject, Defer) the SMTP process is the master process and MAP monitors the SMTP session to acquire the data required to complete, or attempt to complete, authentication of the senders address.

In essence MAP is performing the same process as the server that established the SMTP connection to send inbound mail except the MAP process is limited to authenticating that the published return route for the sender's domain specifies a live host, that the specified host supports the industry standard SMTP protocol and can authenticate the senders address when submitted as the RCPT TO: address. If the MAP process proceeds to the last verification step, immediately upon receipt of the response to the RCPT TO: or if the MAP timeout variable for this sequence of the MAP process is exceeded, a QUIT command is issued by MAP and the connection established by MAP for verification purposes only, is closed.

The MAP system performs several preliminary checks immediately upon receiving the inbound SMTP connection and reserves the on-line verification of a senders address as the last and final step of the MAP authentication process; For example: Where there are many large ISP's/email service providers such as AOL, Hotmail, MSN and Yahoo, and where some aspects of the mail systems and service infrastructure of these networks is understood by the inventor, and that outbound mail originating from these large ISP networks may only be expected to be processed by hosts (mail servers) known to be part of or resident on these networks, that the MAP system will identify whether the senders address is being forged. A forged address is implied when for example a correspondent with a sender address @aol.com establishes an SMTP connection from other then an AOL host.

MAP also utilizes a combination of static and dynamically updated ‘white list and black lists. Each day any fully qualified sender address that is verified by MAP is dynamically added to the systems global white list. This white list is checked first each time MAP detects/monitors a new inbound SMTP connection and if the senders address matches an existing white list entry, MAP instructs the SMTP process to Accept the inbound correspondence.

Customer mail service administrators maintain static white and black lists. White list entries are typically created/maintained proactively by domain level administrator to permit expected email traffic sent by automated notification systems or “list servers” as most automated email notification systems, and/or list servers will not respond to a MAP address verification requests and barring a white list entry the mail will be deferred or rejected. The invention includes a series of software programs and MAP algorithms some of which operate in the form of ‘milters’ which is the term used for SMTP mail filtering instructions. The software programs and MAP algorithms are copyright and trade secret protected and while they have been identified herein, legal protection for this aspect of the system may be via copyright, trade secret and other laws and the complete application will address this issue.

End of Provisional Patent Application

What is claimed is:

1. A system and method for verifying if an electronic message (i.e. email using SMTP structures) which claims to be from a particular sender and emanating from a particular location on the internet (i.e. from a specific network connected to the internet) has in fact been sent by that sender and from that network.

2. A system and method for verifying if an electronic message (i.e. email using SMTP structures) which claims to be from a particular sender and emanating from a particular location on the internet (i.e. from a specific network connected to the internet) has in fact been sent by that sender and from that network and where such verification is achieved without the email message being verified ever having to be actually received by the intended recipient.

3. A system and method for independently evaluating every incoming email message at the receiving email server to determine if the message contains a false, forged or unverifiable sender address, which method does not require any change in SMTP, Internet or DNS protocols and standards, and does not require any change in the operations or configuration of the mail server sending or receiving the email message, the method comprising;
(a) Adding a separate and independent process to a receiving email server executing SMTP to passively acquire the fully qualified email address of the sender as per the SMTP “Mail from:” and the IP address of the sending server that connected to the receiving server; and
(b) Simultaneously using the acquired information, execute a series of verification tests to determine if the sender address is false, forged or unverifiable, such tests performed independently and without interference of the SMTP process; and
(c) Recording in a log file or database facility separate from the SMTP transaction logging facility, the detailed results of the verification tests performed for every incoming message; which verification tests are not redundant or duplicitous with respect to the standard verification tests performed by the SMTP process itself; and
(d) Optionally; signal the unique SMTP process receiving the email message based on the results of the verification tests, as to whether the receiving email server should accept delivery of the email from the sending server, or not to accept delivery of the email message from the sending server.
